(19) United States
(12) Patent Application Publication
(10) Pub. No.: US 2008/0059980 A1
(43) Pub. Date: Mar. 6, 2008

(54) Network device

(75) Inventor: Akira Kataoka, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/899,032

(22) Filed: Sep. 4, 2007

(30) Foreign Application Priority Data
Sep. 5, 2006 (JP) 2006-239671

(51) Int. Cl. G06F 3/00

(52) U.S. Cl. 719/321

(57) ABSTRACT

In a network device constituting a distributed application environment, the network device includes a communication unit for communicating with others via a network, a storage unit, and an operation control unit for reading an operating system from the storage unit to operate and reading an application from the storage unit to operate on the operating system. An abstraction function operated under the operating system processes such that converting an implemented identifier into a device identifier based on received device operation request to an function on device from the application by way of a generated object, making a permission or a rejection of the device operation request determined thereby, and carrying out an operation for the function on device by way of the operating system.

This application is based on and claims priority from Japanese Patent Application No. 2006-239671, filed on Sep. 5, 2006, the entire contents of which are hereby incorporated by reference.

### BACKGROUND OF THE INVENTION

1. Technical Field

The present invention relates to a network device constituting a distributed application environment, particularly relates to a network device in which an application operated on the network device can use a function on device regardless of an identifier of a function on device implemented in an application.

2. Background Art

There are the following Patent Documents related to a distributed application environment in which an application is executed as a whole by distributedly operating the application by utilizing resources of a plurality of network device connected to each other:

Patent Document 1: JP-A-09-114791

Patent Document 2: JP-A-10-040229

FIG. 9 is a constitution block diagram showing an example of such a distributed application environment of the background art. In FIG. 9, numerals 1, 2, 3 and 4 designate network devices in which applications are distributedly operated, numeral 100 designates a general-purpose network such as Local Area Network (LAN), Wide Area Network (WAN) or the like.

The network devices 1-4 are mutually connected to each other in the network 100.

Further, FIG. 10 is a constitution block diagram showing details of a network device. In FIG. 10, numeral 5 designates communication unit for communicating with others via the network 100, numeral 6 designates operation control unit such as Central Processing Unit (CPU), Micro Processing Unit (MPU) or the like, numeral 7 designates storage unit such as hard disk, Random Access Memory (RAM), Read Only Memory (ROM), a flash memory or the like. Further, numeral 5, 6 and 7 constitute a network device 50.

Input/output on one side of the communication unit 5 connect to the network (not shown), input/output on other side thereof is connected to the operation control unit 6. Further, input/output of the storage unit 7 and operation control unit 6 are connected to each other.

Here, an operation of the network device shown in FIG. 10 will be explained in details in reference to FIGS. 11-15. FIGS. 11-12 are explanatory views showing a relationship between applications installed to the network device and a resource of the network device or the like. FIG. 13 is an explanatory view showing an example of an implemented identifier of the application. FIGS. 14-15 are explanatory views for explaining a use of a function on device by the application.

In a network device indicated by notation “NDO1” in FIG. 11, an application installed as indicated by notation “AP01” in FIG. 11 is operated under Operating System (OS) indicated by notation “OS01” operated under a hardware indicated by notation “HW01” in FIG. 11.

Under such a situation, some of applications indicated by notation “AP01” in FIG. 11 use a function on device such as a digital input/output (DI/DO) implemented to the installed network device.

In FIG. 12, notation “ND11” indicates a network device, notation “AP11” indicates an application using a function on device, notation “OS11” indicates an operating system and notation “HW11” designates hardware.

Further, notation “FC11” in FIG. 12 designates a digital input function (DI) constituting a function on device. Notation “FC11” in FIG. 12 indicates a digital output function (DO) constituting a function on device. Further, notation “LT11” in FIG. 12 indicates a list described with an identifier that is implemented in application for operating a function on device (hereinafter, referred to as an implemented identifier).

For example, such a list of the implemented identifier is as indicated by notation “LT21” in FIG. 13. In the list of the implemented identifier indicated by notation “LT21” in FIG. 13, identifiers of a digital input function (DI) and a digital output function (DO) used by the application indicated by notation “AP11” in FIG. 12 are respectively “Switch 1” and “Switch 2”.

Here, when an application indicated by notation “AP11” in FIG. 14 operates a function on device, an input operation or an output operation is carried out for the function on devices such as digital input/output (DI/DO), using the implemented identifier.

For example, when the application indicated by notation “AP11” acquires information from outside of the network device by operating the digital input function (DI), a usable implemented identifier “Switch 1” of the digital input function (DI) is fetched from a list indicated by notation “LT21” in FIG. 14.

Then, the digital input function (DI), which is indicated by notation “FC11” in FIG. 14 and constitutes a portion of hardware indicated by notation “HW11” in FIG. 14, is operated by way of an operating system indicated by notation “OS11” in FIG. 14 using the implemented identifier.

However, assume that the identifier in the network device of the digital input function (DI) indicated by notation “FC11” in FIG. 14 (hereinafter, referred to as device identifier) is “Switch 1” the same as an implemented identifier implemented to the application as indicated by notation “EI31” in FIG. 14.

Similarly, for example, when an application indicated by notation “AP11” in FIG. 14 outputs information to outside of the network device by operating the digital output function (DO), a usable implemented identifier “Switch 2” of the digital output function (DO) is fetched from the list indicated by notation “LT21” in FIG. 14.

Then, with using the implemented identifier, the digital output function (DO), which is indicated by notation “FC12” in FIG. 14 and constitutes the portion of the hardware indicated by notation “HW11” in FIG. 14, is operated by way of the operating system indicated by notation “OS11” in FIG. 14.

However, assume that the identifier at inside of the network device of the digital output function (DO) indicated by notation “FC12” in FIG. 14 is “Switch 2” the same as an implemented identifier implemented in the application as indicated by notation “EI32” in FIG. 14.

As a result, by providing the lists described with the implemented identifiers for operating the function on devices to the application installed on the network device, the application can operate the function on devices such as the digital input/output (DI/DO) on the network device.

However, according to the network device constituting the distributed application environment, even when the function on devices usable for the respective device are constituted by the same function such as digital input function (DI), it is not guaranteed that device identifiers set for the respective device are the same. Therefore, there is a problem that although the functions on a network device has same function (for example, digital input function (DI) or the like), some applications cannot use the function if they are set with a different device identifier.

For example, assume a case where an application indicated by notation “AP11” in FIG. 14 is installed to a different network device indicated by notation “ND41” in FIG. 15. However, device identifiers of the digital input function (DI) and the digital output function (DO) as indicated by notation “FC41” and notation “FC42” in FIG. 15 are indicated by notation “DI-32” and notation “DO-33” as indicated by notation “EI41” and notation “EI42” in FIG. 15.

Under such a situation, for example, when the application indicated by notation “AP11” in FIG. 15 acquires information from outside of the network device by operating the digital input function (DI), the usable implemented identifier “Switch 1” of the digital input function (DI) is fetched from reference to a list indicated by notation “LT21” in FIG. 15.

Then, even when the digital input function (DI), which is indicated by notation “FC41” in FIG. 15 and constitutes a portion of the hardware indicated by notation “HW41” in FIG. 15, is intended to operate by way of an operating system indicated by notation “OS41” in FIG. 15 based on the implemented identifier, the implemented identifier “Switch 1” and the device identifier “DI-32” do not coincide with each other, and therefore, the digital input function (DI) indicated by notation “FC41” in FIG. 15 cannot be operated.

Similarly, for example, when the application indicated by notation “AP11” in FIG. 15 outputs information to outside of the network device by operating the digital output function (DO), the usable implemented identifier “Switch 2” of the digital output function (DO) is fetched from reference to the list indicated by notation “LT21” in FIG. 15.

Then, even when the digital output function (DO), which is indicated by notation “FC42” in FIG. 15 and constitutes a portion of the hardware indicated by notation “HW41” in FIG. 15, is intended to operate by way of the operating system indicated by notation “OS41” in FIG. 15 based on the implemented identifier, the implemented identifier “Switch 2” and the device identifier “DO-33” do not coincide with each other, and therefore, the digital output function (DO) indicated by notation “FC42” in FIG. 15 cannot be operated.

That is, there poses a problem that in order to use the functions on device of all of the network devices constituting the distributed application environment by the application, it is necessary to correct the implemented identifier of the application for the respective network device to be installed.

Further, there poses a problem that when an application installed to the network device is permitted to operate the function on device unconditionally, there is a risk of adversely affecting the devices connected to the function on network device.

Therefore, a problem to be resolved by the invention is to realize a network device capable of using a function on device regardless of an identifier of a function on device implemented in an application.

### SUMMARY OF THE INVENTION

In order to achieve the problem, according to a first aspect of the present invention, a network device constituting a distributed application environment, the network device comprising:

a communication unit for communicating with others via a network;

a storage unit; and

an operation control unit for reading an operating system from the storage unit to operate and reading an application from the storage unit to operate on the operating system,

wherein an abstraction function operated under the operating system processes such that:

converting an implemented identifier into a device identifier based on received device operation request to a function on device from the application by way of a generated object;

making a permission or a rejection of the device operation request determined thereby; and

carrying out an operation for the function on device by way of the operating system.

According to the network device, the function on device can be used regardless of the identifier of the function on device implemented in the application. Further, by carrying out an access control of the function on device, a risk of adversely affecting the devices connected to the function on network device can be prevented.

According to a second aspect of the present invention as set forth in the first aspect of the present invention, it may be adapted that the application requests to generate the object by providing the implemented identifier to the abstraction function, and waits until the object is generated, and carries out an operation request of the function on device for the generated object.

According to the network device, the function on device can be used regardless of the identifier of the function on device implemented in the application. Further, by carrying out the access control of the function on device, a risk of adversely affecting the devices connected to the function on network device can be prevented.

According to a third aspect of the present invention as set forth in the second aspect of the present invention, it may be adapted that when the object receives the operation request of the function on device from the application, the object generates the function operation request based on the operation request of the function on device, and delivers the generated function operation request to the abstraction function.

According to the network device, the function on device can be used regardless of the identifier of the function on device implemented in the application. Further, by carrying out the access control of the function on device, a risk of adversely affecting the devices connected to the function on network device can be prevented.

According to a fourth aspect of the present invention as set forth in the first aspect of the present invention, it may be adapted that when the abstraction function receives a request for generating the object from the application, the abstraction function generates the object based on the provided implemented identifier.

According to the network device, the function on device can be used regardless of the identifier of the function on device implemented in the application. Further, by carrying out the access control of the function on device, a risk of adversely affecting the devices connected to the function on network device can be prevented.

According to a fifth aspect of the present invention as set forth in the first aspect of the present invention, it may be adapted that when the abstraction function receives the device operation request from the object, the abstraction function selects a binding function suitable for the implemented identifier provided to the application and converts the implemented identifier into the device identifier, and

the abstraction function makes an access control function determine the permission or the rejection of the device operation request, and

when the access control function determines as the permission, the abstraction function makes a drive function operate the function on device based on the device operation request.

According to the network device, the function on device can be used regardless of the identifier of the function on device implemented in the application. Further, by carrying out the access control of the function on device, a risk of adversely affecting the devices connected to the function on network device can be prevented.

According to a sixth aspect of the present invention as set forth in the fifth aspect of the present invention, it may be adapted that the binding function converts the implemented identifier into the device identifier by managing binding information for binding the implemented identifier implemented in the application and the device identifier set with the installed network device.

According to the network device, the function on device can be used regardless of the identifier of the function on device implemented in the application. Further, by carrying out the access control of the function on device, a risk of adversely affecting the devices connected to the function on network device can be prevented.

According to a seventh aspect of the present invention as set forth in the fifth aspect of the present invention, it may be adapted that the access control function determines the permission or the rejection of the device operation request by controlling access control information of the operation on the function on device of the application.

According to the network device, the function on device can be used regardless of the identifier of the function on device implemented in the application. Further, by carrying out the access control of the function on device, a risk of adversely affecting the devices connected to the function on network device can be prevented.

According to an eighth aspect of the present invention as set forth in the fifth aspect of the present invention, it may be adapted that the drive function carries out an operation of the function on device by selecting a driver necessary for operating the function on device based on the device operation request.

According to the network device, the function on device can be used regardless of the identifier of the function on device implemented in the application. Further, by carrying out the access control of the function on device, a risk of adversely affecting the devices connected to the function on network device can be prevented.

According to a ninth aspect of the present invention as set forth in the first aspect of the present invention, it may be adapted that the function on device is a function on an external connection device.

According to the network device, the load function of the external connection device can be used regardless of the identifier of the function on device implemented in the application.

According to a tenth aspect of the present invention as set forth in the first aspect of the present invention, it may be adapted that the object generates the device operation request suitable for a method of operating the function on device based on the operation request from the application and delivers the generated device operation request to the abstraction function.

According to the network device, the function on device of the network device can be used without being conscious of the method of operating the function on device that differs by the respective network device.

According to the invention, there are following effects.

According to the first aspect to the eighth aspect of the present invention, the abstraction function converts the implemented identifier into the device identifier based on the device operation request, which acquired by way of the object, to the function on device from the application, and the permission or the rejection of the device operation request is determined, the operation for the function on device is carried out by way of the operating system, thereby, the function on device can be used regardless of the identifier which is implemented in the application of the function on device.

Further, according to the ninth aspect of the present invention, the function on device is the function of the external connection device, thereby, also the function of the external connection device can be used regardless of the identifier which is implemented in the application of the function on device.

Further, according to the tenth aspect of the present invention, the object generates the device operation request suitable for the method of operating the function on device based on the operation request from the application, the generated device operation request is delivered to the abstraction function, thereby, the function on device of the network device can be used without being conscious of the method of operating the function on device which differs for the respective network device.

### BRIEF DESCRIPTION OF THE DRAWINGS

FIG. 1 is a constitution block diagram showing an embodiment of a network device according to the invention;

FIG. 2 is an explanatory view showing a relationship between an application installed to a network device and a resource of the network device or the like;

FIG. 3 is a flowchart for explaining operation of an operation control unit;

FIG. 4 is an explanatory view for explaining use of a function on device by an application;

FIG. 5 is a flowchart for explaining operation of the operation control unit;

FIG. 6 is a flowchart for explaining operation of the operation control unit;

FIG. 7 is a flowchart for explaining operation of the operation control unit;

FIG. 8 is an explanatory view for explaining use of a function on device by an application;

FIG. 9 is a constitution block diagram showing an example of a distributed application environment of the background art;

FIG. 10 is a constitution block diagram showing details of a network device;

FIG. 11 is an explanatory view showing a relationship between an application installed to a network device and a resource of the network device or the like;

FIG. 12 is an explanatory view showing a relationship between an application installed to a network device and a resource of the network device or the like;

FIG. 13 is an explanatory view showing an example of an implemented identifier of an application;

FIG. 14 is an explanatory view for explaining use of an function on device by an application; and

FIG. 15 is an explanatory view for explaining use of an function on device by an application.

### DETAILED DESCRIPTION OF EXEMPLARY EMBODIMENTS

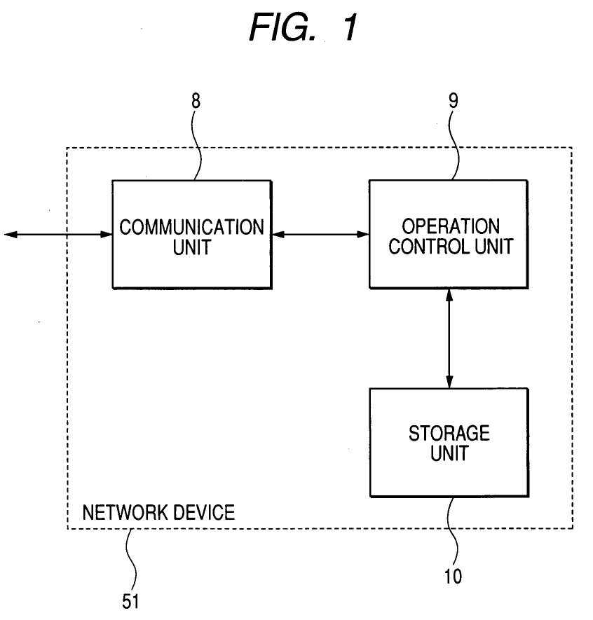

The invention will be described in details in reference to the drawings as follows. FIG. 1 is a constitution block diagram showing an embodiment of a network device according to the present invention.

In FIG. 1, numeral 8 designates communication unit for communicating with others via a network (not shown), numeral 9 designates operation control unit such as CPU, MPU or the like, numeral 10 designates storage unit such as a hard disk, RAM, ROM, a flash memory or the like. Further, numerals 8-10 constitute network devices 51.

Input/output on one side of the communication unit 8 and the network (not shown) are connected to each other, input/output on other side and the operation control unit 9 are connected to each other. Further, input/output of the storage unit 10 and the operation control unit 9 are connected to each other.

In the network device 51 shown in FIG. 1, the operation control unit 9 reads and operates an operating system stored in the storage unit. 10 and reads an application stored in the storage unit 10 to be operated under the operating system. Further, the operation control unit 9 communicates with other network device by way of the network (not shown) by controlling the communication unit 8.

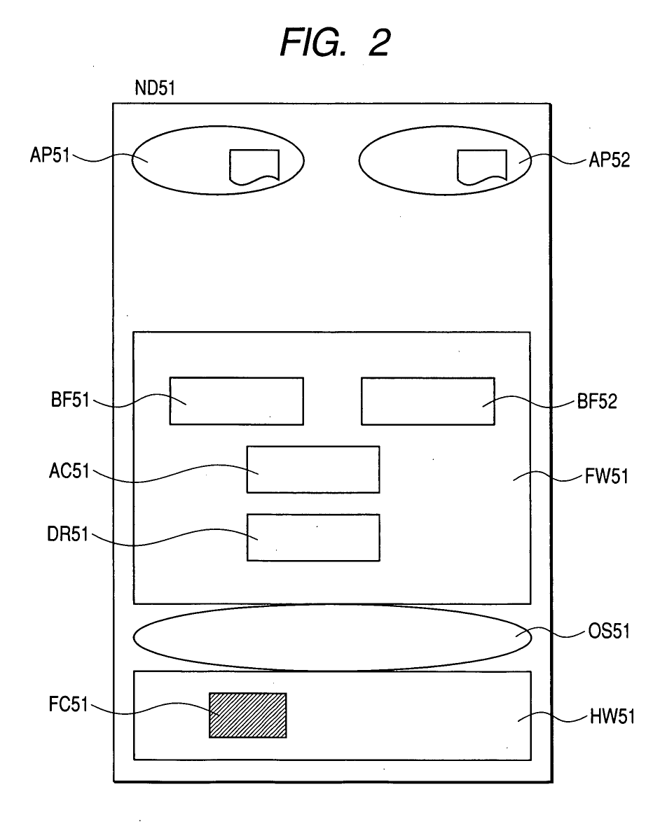

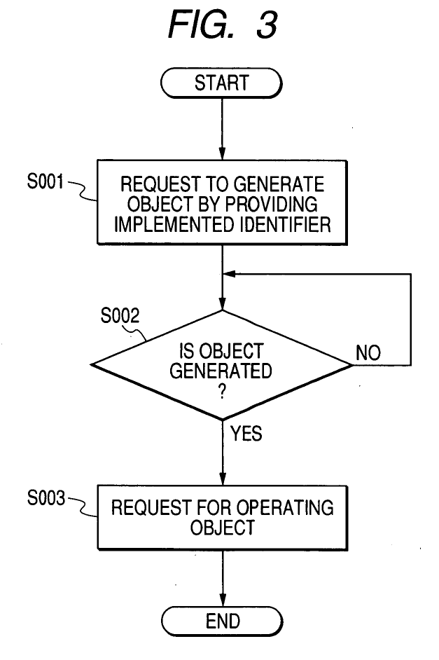

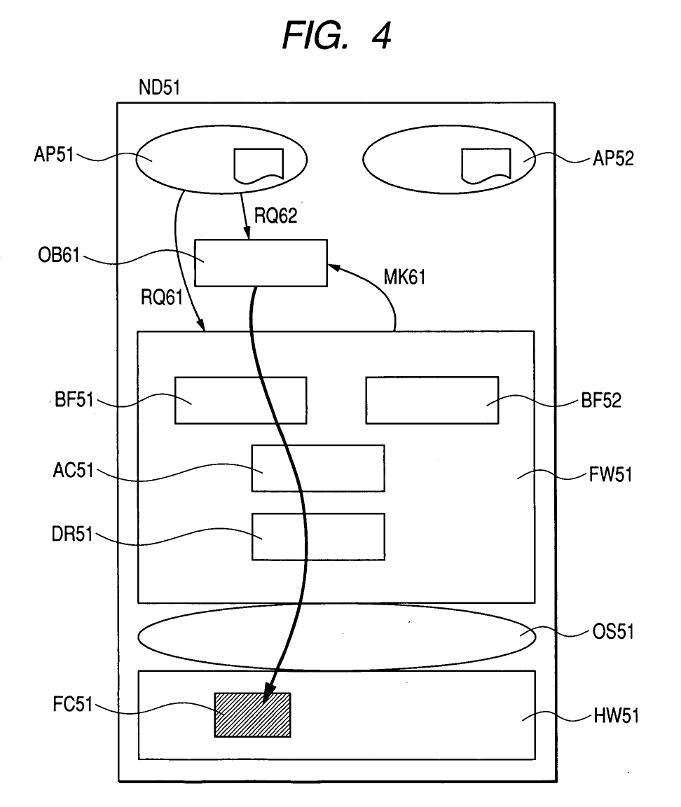

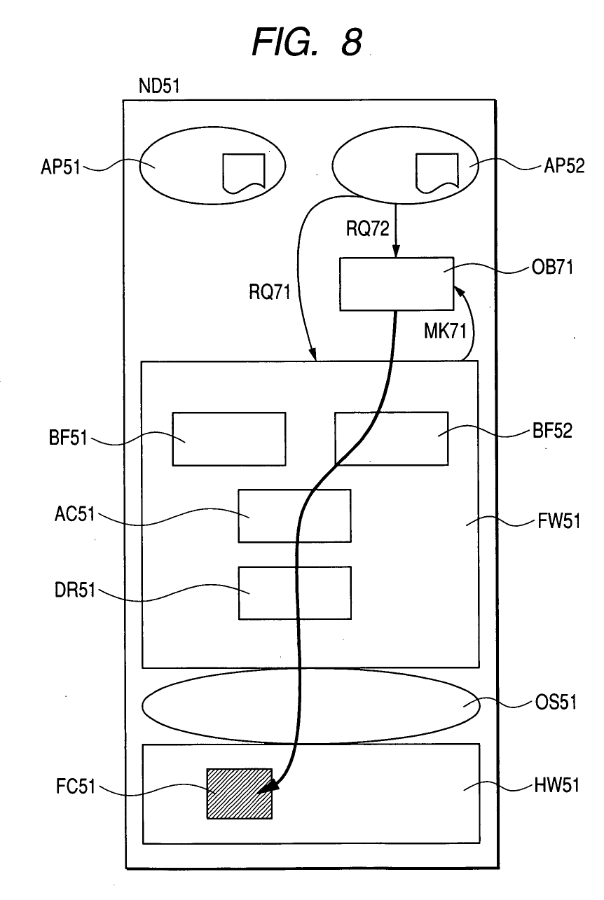

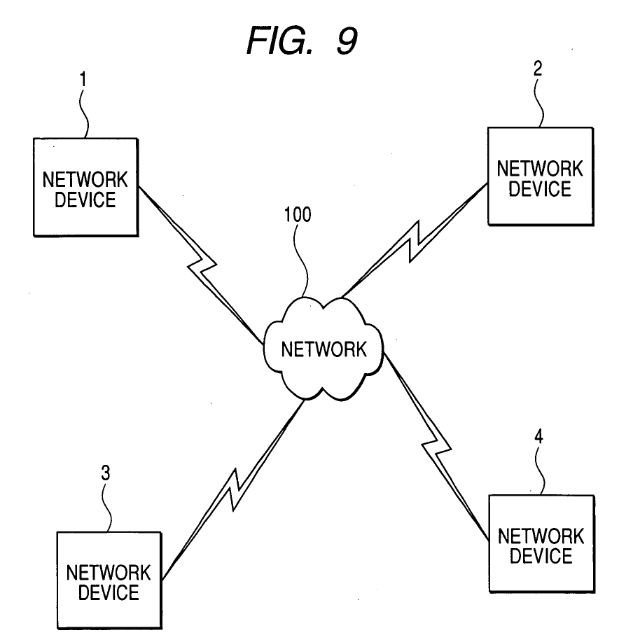

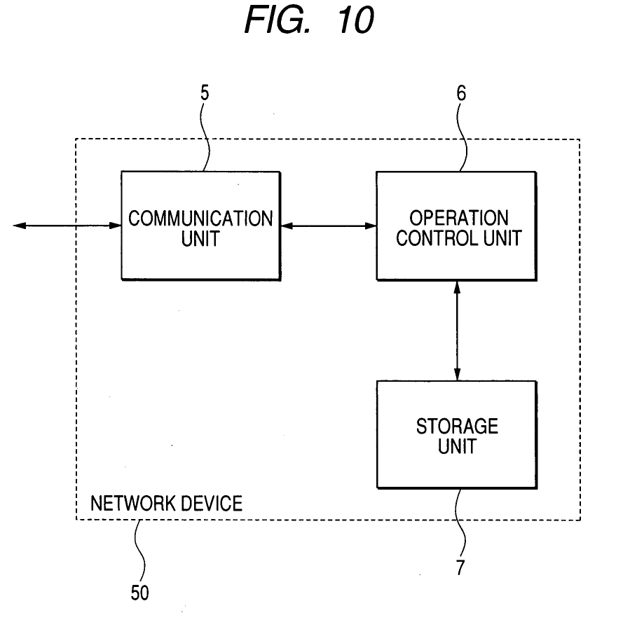

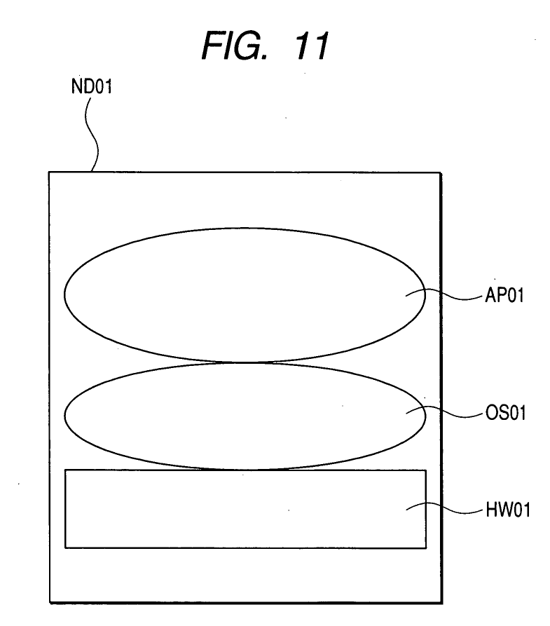

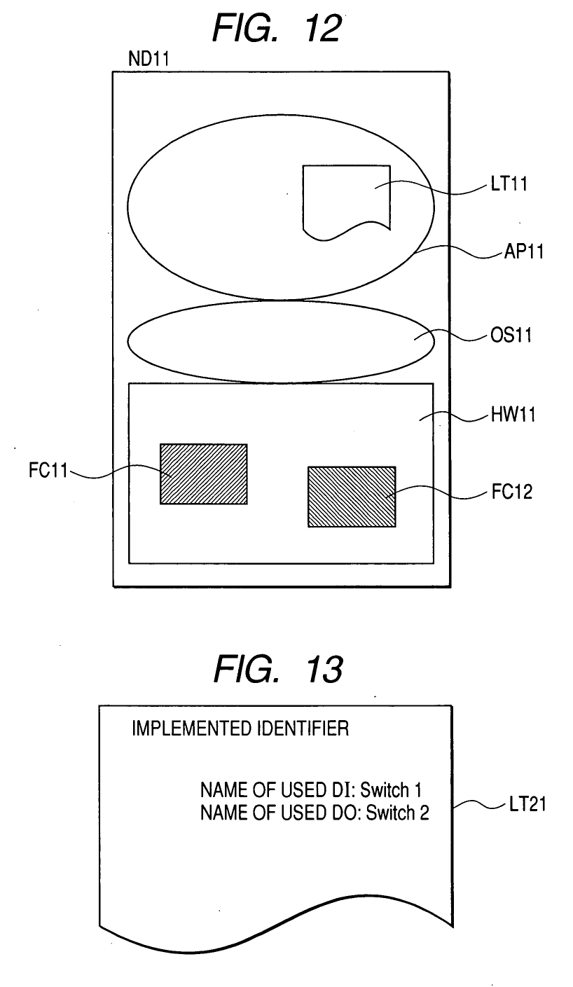

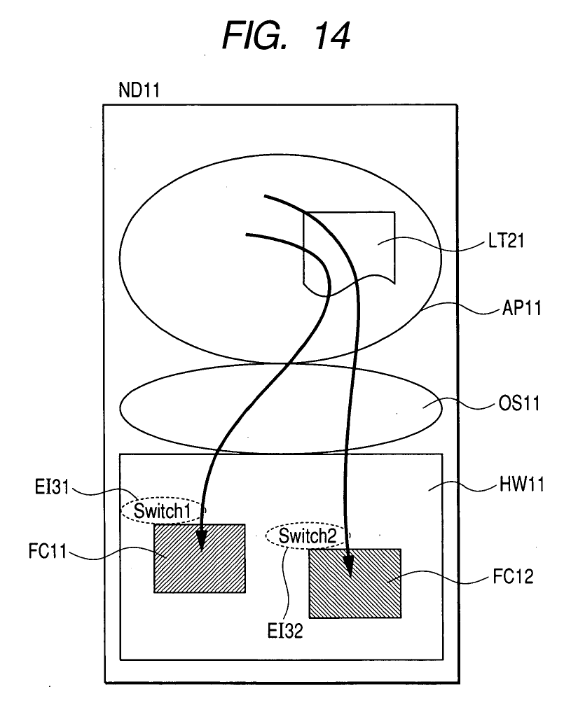

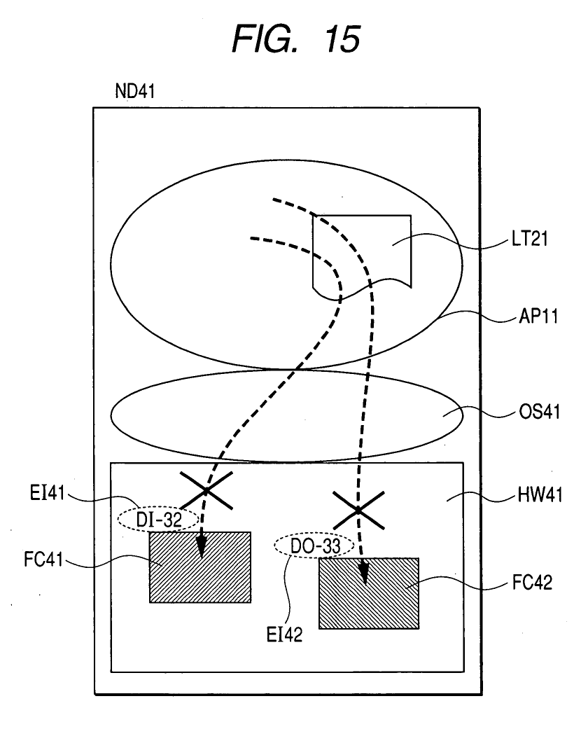

Here, an operation of the embodiment shown in FIG. 1 will be described in details in reference to FIGS. 3-8. FIG. 2 is an explanatory view showing a relationship between an application installed to a network device and a resource of the network device or the like. FIGS. 3 and 5-7 are flowcharts, FIGS. 4 and 8 are explanatory views for explaining use of a function on device by an application.

In FIG. 2, notation “ND51” designates a network device. Notations “AP51” and “AP52” designate applications using a function on device. Notation “OS51” designates an operating system. Notation “HW51” designates hardware (resource) of the operation control unit 9, the storage unit 10 and the like.

Further, notation “FC51” in FIG. 2 designates a digital input function (DI) constituting a function on device of a network device, or a digital output function (DO) constituting a function on device of a network device.

Further, notation “FW51” designates an abstraction function operated under the operating system, the abstraction function further includes: binding functions designated by notation “BF51” and notation “BF52” in FIG. 2; an access control function designated by notation “AC51” in FIG. 2; and a drive function indicated by notation “DR51” in FIG. 2, respectively. Further, the respective functions are as follows.

The binding functions indicated by notation “BF51” and notation “BF52” in FIG. 2 are functions of converting from an implemented identifier to a device identifier as necessary by controlling binding information for binding the implemented identifier implemented in the application and the device identifier provided from an installed network device, which is prepared for the abstraction function by a number of installed applications.

The access control function designated by notation “AC51” in FIG. 2 determines permission or rejection of an operation request (actually, device operation request) from the application by using information on availability of operation (access control information) regarding function on devices for respective applications.

A drive function designated by notation “DR51” in FIG. 2 operates the function on device by selecting a driver or the like necessary for operating the function on device based on the operation request from the application (actually, device operation request).

In the network device shown in FIG. 1, an installed application designated by notation “AP51” (or “AP52”) in FIG. 2 is operated under OS designated by notation “OS51” in FIG. 2 operated under the hardware designated by notation “HW51” in FIG. 2.

Under such a situation, the application designated by notation “AP51” in FIG. 2 uses a function on device (a digital input/output (DI/DO) or the like) indicated by notation “FC51” in FIG. 2 equipped with the network device, in which the application is installed, by way of the abstraction function designated by notation “FW51” in FIG. 2.

At “S001” in FIG. 3, the application requests to generate an object by providing the implemented identifier to the abstraction function, and at “S002” in FIG. 3, the application waits until the object is generated.

For example, as shown by notation “RQ61” in FIG. 4, the application designated by notation “AP51” in FIG. 4 requests the abstraction function indicated by notation “FW51” in FIG. 4 to generate the object.

At “S003” in FIG. 3, the application requests to operate the function on device to the generated object.

For example, the application designated by notation “AP51” in FIG. 4 requests to operate the function on device as designated by notation “RQ62” in FIG. 4 to the object designated by notation “OB61” in FIG. 4 generated as shown by notation “MK61” in FIG. 4.

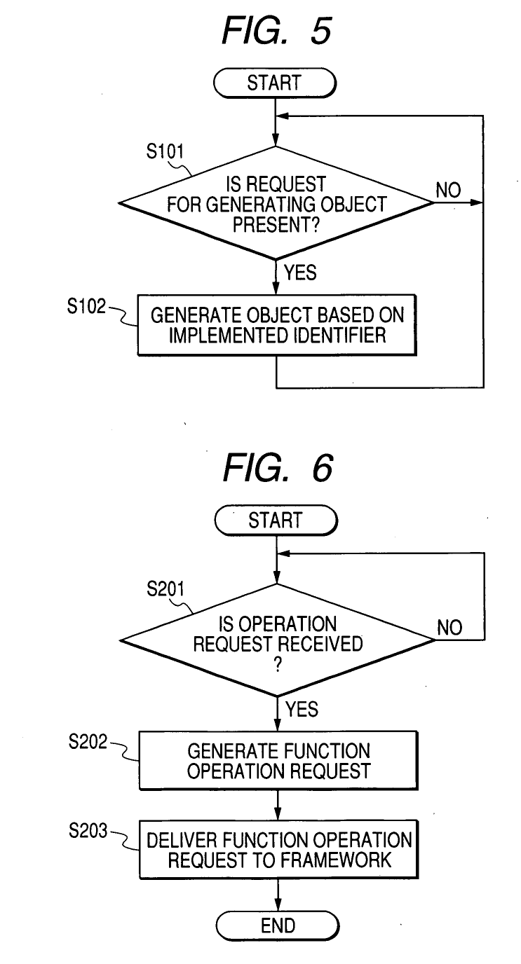

On the other hand, at “S101” in FIG. 5, the abstraction function determines presence/absence of the request of generating the object from the application, and when it is determined that there is a request for generating the object, at “S102” in FIG. 5, the abstraction function generates the object based on the provided implemented identifier.

For example, the abstraction function designated by notation “FW51” in FIG. 4 generates the object designated by notation “OB61” in FIG. 4 as designated by notation “MK61” in FIG. 4 when there is the request for generating the object from the application as designated by notation “RQ61” in FIG. 4.

Further, at “S201” in FIG. 6, the generated object waits until receiving the request for operating the function on device from the application. At “S202” in FIG. 6, the object generates the function operation request based on the request for operating the function on device, and delivers the generated function operation request to the abstraction function at “S203” in FIG. 6.

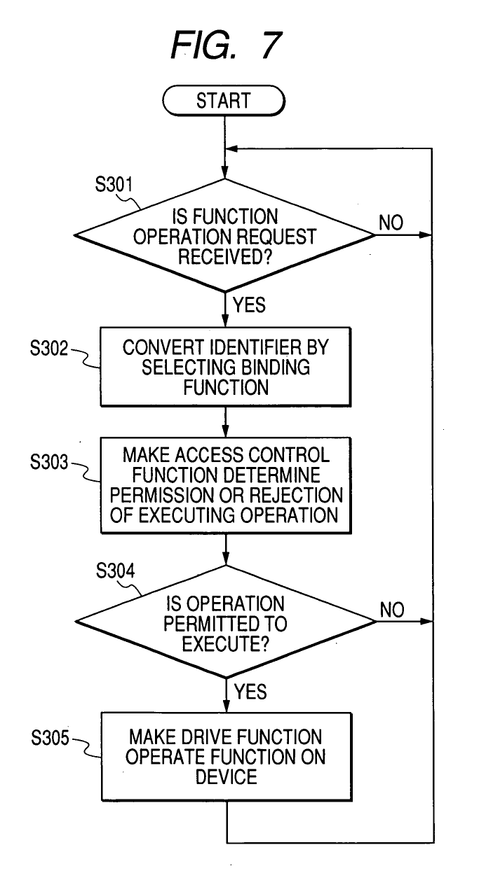

At “S301” in FIG. 7, the abstraction function determines presence/absence of the device operation request from the object, and when it is determined at there is the device operation request, at “S302” in FIG. 7, the abstraction function converts the implemented identifier to the device identifier by selecting a binding function suitable for the implemented identifier implemented in the application.

For example, when the application indicated by notation “AP51” in FIG. 4 is provided with “Switch” as the implemented identifier of the function on device designated by notation “FC51” in FIG. 4, and the binding function designated by notation “BF51” in FIG. 4 is provided with binding information for converting the implemented identifier “Switch” into a device identifier “IDxx”, the abstraction function designated by notation “FW51” in FIG. 4 selects the binding function designated by notation “BF51” and converts the implemented identifier “Switch” into the device identifier “IDxx”.

Further, at “S303” in FIG. 7, the abstraction function makes the access control function determine permission or rejection of the device operation request. At “S304 in FIG. 7, when the abstraction function determines the permission determined by the access control function, at “S305” in FIG. 7, the abstraction function makes the drive function operate the function on device based on the device operation request.

For example, the abstraction function indicated by notation “FW51” in FIG. 4 makes the access control function designated by notation “AC51” in FIG. 4 determine permission or rejection of the device operation request to carry out operation for the function on device designated by notation “FC51” in FIG. 4. If the access control function permits to operate, the abstraction function operates the function on device by way of the operating system designated by notation “OS51” in FIG. 4 by using the drive function designated by notation “DR51” in FIG. 4.

Similarly, when, for example, the application designated by notation “AP52” in FIG. 8 uses the function on device, operation becomes as follows.

That is, as indicated by notation “RQ71” in FIG. 8, the application designated by notation “AP52” in FIG. 8 requests the abstraction function designated by notation “FW51” in FIG. 8 to generate the object.

The application designated by notation “AP52” in FIG. 8 requests to operate the function on device as indicated by notation “RQ72” in FIG. 8 to the object designated by notation “OB71” in FIG. 8 generated as indicated by notation “MK71” in FIG. 8.

When the abstraction function designated by notation “FW51” in FIG. 8 receives the request for generating the object from the application as indicated by notation “RQ71” in FIG. 8, the abstraction function generates the object designated by notation “OB71” in FIG. 8 as designated by notation “MK71” in FIG. 8.

When the application designated by notation “AP52” in FIG. 8 is provided with “0x0199” as the implemented identifier of the function on device designated by notation “FC51” in FIG. 8, and the binding function designated by notation “BF52” in FIG. 8 has the binding information for converting the implemented identifier “0x0199” to the device identifier “IDxx”, the abstraction function designated by notation “FW51” in FIG. 8 selects the binding function designated by notation “BF52” in FIG. 8 and makes the binding function convert the implemented identifier “0x0199” into the device identifier “IDxx”.

Finally, the abstraction function designated by notation “FW51” in FIG. 8 makes the access control function indicated by notation “AC51” in FIG. 8 determine permission or rejection of the device operation request to carries out an operation for the function on device designated by notation “FC51” in FIG. 8. If the access control function permits to operate, the abstraction function operates the function on device by way of the operating system designated by notation “OS51” in FIG. 8 by using the drive function designated by notation “DR51” in FIG. 8.

As a result, the abstraction function converts the implemented identifier into the device identifier based on the device operation request from the application to the function on device by way of the object, and makes the permission or rejection of the device operation request determined thereby, and carries out an operation for the function on device by way of the operating system. Thus, the function on device can be used regardless of the identifier of the function on device implemented in the application.

Further, a risk of adversely affecting the device connected to the function on device can be prevented by the access control of the function on device by the access control function.

Further, while the description of the embodiment shown in FIG. 1 has been described in connection with the case of using the function on the network device installed with the application, by using the function by way of the abstraction function, a function on an external connection device can be also used regardless of the identifier of the function on device implemented in the application.

Further, while the description of the embodiment shown in FIG. 1 has been described about the conversion between the implemented identifier and the device identifier which differs for the respective device by the abstraction function, there is a case in which a method of operating the function on devices of the respective network device from the application also differs by the respective network device.

That is, even when the implemented identifier is converted into the device identifier by the abstraction function, in a case where the method of operating the function on device indicated by the device identifier differs, depending on the application, despite the same function (for example, digital input function (DI) or the like), the function on device of the network device set with the different operating method cannot be used.

In this case, the case is resolved in such a manner that the object generated by the abstraction function generates an device operation request suitable for a operating method of the function on device which differs for the respective network device based on the operation request from the application to deliver to the abstraction function.

By providing the function to the object, the application can use the function on device of the network device by only requesting to operate the function on device to the object without being conscious of the method of operating the function on device that differs for the respective network device.

As a result, by generating the device operation request suitable for the method of operating the function on device based on the operation request from the application to deliver to the abstraction function by the object generated by the abstraction function, the function on device of the network device can be used without being conscious of the method of operating the function on device which differs for the respective network device.

While there has been described in connection with the exemplary embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

What is claimed is:

1. A network device constituting a distributed application environment, the network device comprising:
a communication unit for communicating with others via a network;
a storage unit; and
an operation control unit for reading an operating system from the storage unit to operate and reading an application from the storage unit to operate on the operating system,
wherein an abstraction function operated under the operating system processes such that:
converting an implemented identifier into a device identifier based on received device operation request to a function on device from the application by way of a generated object;
making a permission or a rejection of the device operation request determined thereby; and
carrying out an operation for the function on device by way of the operating system.

2. The network device according to claim 1, wherein the application requests to generate the object by providing the implemented identifier to the abstraction function, and waits until the object is generated, and carries out an operation request of the function on device for the generated object.

3. The network device according to claim 2, wherein when the object receives the operation request of the function on device from the application, the object generates the function operation request based on the operation request of the function on device, and delivers the generated function operation request to the abstraction function.

4. The network device according to claim 1, wherein when the abstraction function receives a request for generating the object from the application, the abstraction function generates the object based on the provided implemented identifier.

5. The network device according to claim 1, wherein when the abstraction function receives the device operation request from the object, the abstraction function selects a binding function suitable for the implemented identifier provided to the application and converts the implemented identifier into the device identifier, and
the abstraction function makes an access control function determine the permission or the rejection of the device operation request, and
when the access control function determines as the permission, the abstraction function makes a drive function operate the function on device based on the device operation request.

6. The network device according to claim 5, wherein the binding function converts the implemented identifier into the device identifier by managing binding information for binding the implemented identifier implemented in the application and the device identifier set with the installed network device.

7. The network device according to claim 5, wherein the access control function determines the permission or the rejection of the device operation request by controlling access control information of the operation on the function on device of the application.

8. The network device according to claim 5, wherein the drive function carries out an operation of the function on device by selecting a driver necessary for operating the function on device based on the device operation request.

9. The network device according to claim 1, wherein the function on device is a function on an external connection device.

10. The network device according to claim 1, wherein the object generates the device operation request suitable for a method of operating the function on device based on the operation request from the application and delivers the generated device operation request to the abstraction function.
